(19) United States
(12) Patent Application Publication
(10) Pub. No.: US 2026/0099780 A1
(43) Pub. Date: Apr. 9, 2026

(54) SCHEDULING SYSTEM FOR SHIFTS

(71) Applicant: MedicalMatch Corporation, Saratoga Springs, UT (US)

(72) Inventors: Astrid Vreugdenhil, Erie, CO (US); Spencer Stirling, Erie, CO (US); Ali Philips, Saratoga Springs, UT (US); Emiola Abdulmueez, Ibadan (NG); Devyansh Kalra, New Delhi (IN)

(21) Appl. No.: 18/909,747

(22) Filed: Oct. 8, 2024

(51) Int. Cl. G06Q 10/0631; G06Q 10/1053

(52) U.S. Cl. CPC G06Q 10/06311; G06Q 10/1053

(57) ABSTRACT

A scheduling system is provided that may be used in the medical or other industry. The scheduling system can facilitate creating, applying for, and scheduling shifts. The scheduling system can be configured to assist employers and clinicians in identifying recommended pay rates for shifts. These recommended pay rates can be generated using artificial intelligence based on previous shifts and clinicians who were scheduled for those shifts.

### CROSS-REFERENCE TO RELATED APPLICATIONS

N/A

### BACKGROUND

Some companies, such as those in the healthcare industry, routinely have shifts that must be filled. Few solutions exist to facilitate scheduling for these shifts.

### BRIEF SUMMARY

Embodiments of the present disclosure are generally directed to a scheduling system that may be used in the medical or other industry. The scheduling system can facilitate creating, applying for, and scheduling shifts. The scheduling system can be configured to assist employers and clinicians in identifying recommended pay rates for shifts. These recommended pay rates can be generated using artificial intelligence based on previous shifts and clinicians who were scheduled for those shifts.

In some embodiments, a scheduling system may implement a method for scheduling a shift. A request to view shifts can be received from a first clinician. The request may specify criteria. One or more shifts that match the criteria of the request, including a first shift offered by a first employer, may be presented to the first clinician. The first shift may include a first pay rate that the first employer is offering to pay for the first shift. Input selecting the first shift for which the first clinician desires to apply may be received. The input may include a second pay rate different from the first pay rate that the first clinician would like to be paid for the first shift. One or more clinicians, including the first clinician, who have applied for the first shift can be presented to the first employer. The first clinician can be presented with the second pay rate rather than the first pay rate.

In some embodiments, a recommended pay rate for the first clinician can be predicted using artificial intelligence. The first clinician may be presented to the first employer with the recommended pay rate for the clinician and the second pay rate.

In some embodiments, the recommended pay rate for the first clinician may be predicted based on characteristics of other clinicians and characteristics of other shifts.

In some embodiments, the first shift may be presented to the first clinician with the recommended pay rate for the first clinician.

In some embodiments, the second pay rate may be the recommended pay rate for the first clinician.

In some embodiments, the second pay rate may be presented as a percentage above or below the first pay rate.

In some embodiments, input that defines the first shift may be received from the first employer. The input may specify the first pay rate.

In some embodiments, the first pay rate may be presented to the first employer as a recommended pay rate for the shift.

In some embodiments, the recommended pay rate for the shift may be predicted using artificial intelligence based on previous shifts that have been scheduled via the scheduling system.

In some embodiments, the criteria of the request to view shifts may include at least one of: one or more medical professions; one or more medical specialties; one or more medical licenses; or one or more medical certificates.

In some embodiments, the first clinician may be presented to the first employer with an indication that the first clinician has not been onboarded to the scheduling system.

In some embodiments, a request to apply for the first shift can be received from a second clinician, and the second clinician can be automatically scheduled for the first shift.

In some embodiments, it can be determined that the second clinician's request to apply for the first shift matches criteria for automatic scheduling, and the second clinician may be automatically scheduled for the first shift in response to the determination.

In some embodiments, determining that the second clinician's request to apply for the first shift matches criteria for automatic scheduling may include determining that one or more of a pay rate specified by the second clinician, a status level of the second clinician, or qualifications of the second clinician matches the criteria for automatic scheduling.

In some embodiments, a scheduling system may implement a method for scheduling a shift. Input that defines a first shift may be received from a first employer. Based on the input that defines the first shift, a recommended pay rate for the first shift may be predicted using artificial intelligence. A plurality of clinicians who have applied for the first shift may be presented to the first employer. Each of the clinicians may be presented with a clinician pay rate. The clinician pay rate for at least one of the clinicians may be different from the recommended pay rate.

In some embodiments, the clinician pay rate for a first clinician of the plurality of clinicians may be selected by the first clinician when applying for the first shift.

In some embodiments, the clinician pay rate for the first clinician may be predicted using artificial intelligence based on characteristics of other clinicians and characteristics of other shifts.

In some embodiments, a scheduling system may implement a method for scheduling a shift. Input defining a first shift can be received from a first employer. The input can include a medical profession for the first shift, a duration of the first shift, and a first pay rate for the first shift. A plurality of shifts including the first shift can be presented to a first clinician. A request to apply for the first shift can be received from the first clinician. The request may specify a second pay rate. A plurality of clinicians, including the first clinician, who have applied for the first shift can be presented to the first employer. The first clinician may be presented with the second pay rate. Input that selects the first clinician to schedule for the first shift can be received from the first employer. The first clinician can be scheduled for the first shift.

In some embodiments, in conjunction with receiving the first pay rate for the first shift from the first employer, a hiring chance prediction based on the first pay rate can be presented to the first employer.

In some embodiments, in conjunction with receiving the second pay rate from the first clinician, a hiring chance prediction based on the second pay rate can be presented to the first clinician.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

These drawings depict only example embodiments and should not be considered limiting of the scope of the disclosed embodiments.

FIG. 1 illustrates an example computing environment in which one or more embodiments may be implemented.

FIG. 2 illustrates example components of a scheduling system for shifts in accordance with one or more embodiments.

FIG. 3 illustrates an example clinician onboarding interface that may be used in one or more embodiments.

FIGS. 4, 4A and 4B illustrate an example shift creation interface that may be used in one or more embodiments.

FIGS. 5, 5A, 5B and 5C illustrate an example opportunities interface that may be used in one or more embodiments.

FIGS. 6, 6A and 6B illustrate an example shift scheduling interface that may be used in one or more embodiments.

### DETAILED DESCRIPTION

In this specification and the claims, the term “employer” should be construed as encompassing any entity that needs to fill shifts. A clinician should be construed as an individual who could fill an employer's shift.

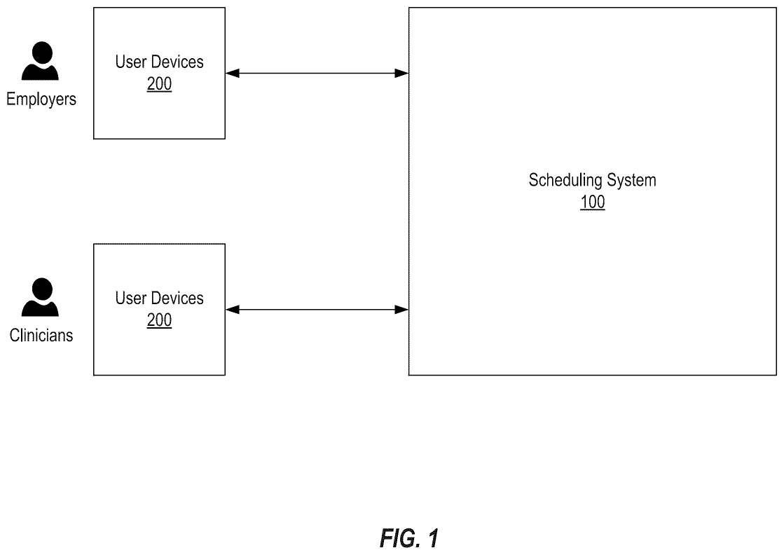

FIG. 1 provides an example of a computing environment in which one or more embodiments of the present disclosure may be implemented. The computing environment may include a scheduling system 100 and user devices 200. Scheduling system 100 may comprise a variety of computing components that may typically be hosted online in a cloud-based environment but could be hosted or implemented in any suitable manner. User devices 200 can represent any computing device that employers or clinicians may use to access the functionality provided by scheduling system 100. For example, user devices 200 could include any computing device with a browser for accessing a website provided by scheduling system 100 or any computing device that can execute an application of scheduling system 100.

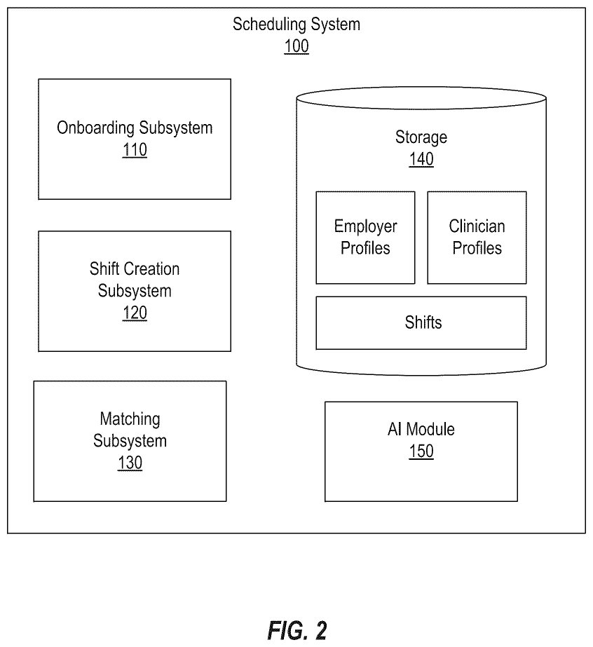

FIG. 2 provides an example of components that may be employed within scheduling system 100 to implement the functionality described herein. Scheduling system 100 may include an onboarding subsystem 110, a shift creation subsystem 120, a matching subsystem 130, storage 140, and an artificial intelligence (AI) module 150, among possibly other components. Onboarding subsystem 110 is configured to implement functionality for onboarding employers and clinicians such as to create employer profiles and clinician profiles. Shift creation subsystem 120 is configured to implement functionality by which employers can create shifts. Matching subsystem 130 is configured to implement functionality for intelligently matching clinicians to shifts for scheduling purposes. AI module 150 can implement one or more machine learning models (or other AI techniques) and can provide an interface by which the other components of scheduling system 100 may access a machine learning model. Storage 140 may store employer profiles, clinician profiles, and data defining shifts, including past and current shifts. AI module 150 can use any data in storage 140 as part of generating and/or maintaining one or more machine learning models.

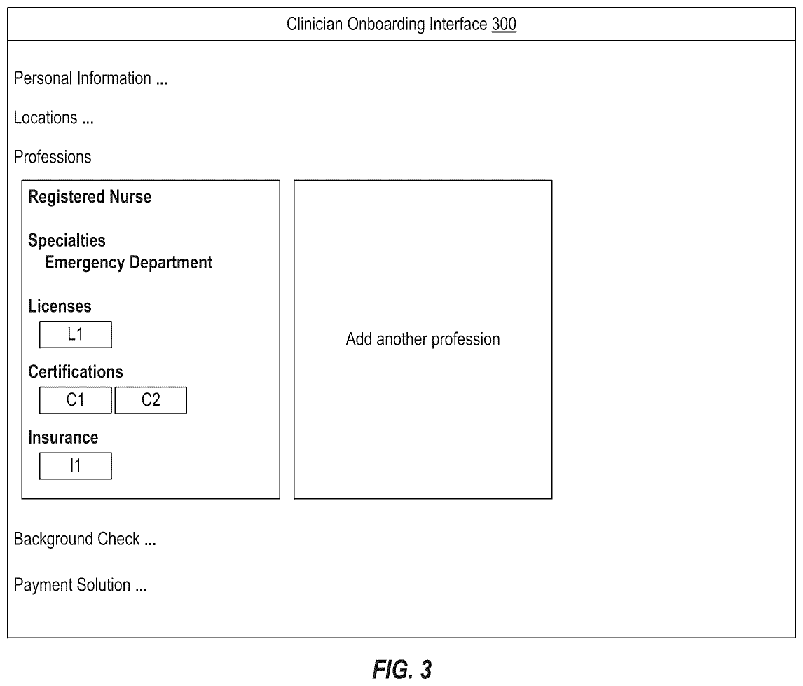

FIG. 3 provides an example of a clinician onboarding interface 300 that onboarding subsystem 110 may present to clinicians (e.g., via one or more webpages or a mobile application) to enable the clinicians to use scheduling system 100 to be hired for shifts. Although not shown, onboarding subsystem 110 can provide a similar interface to employers for onboarding purposes (e.g., to gather the employer's name, contact information, facility locations, payment information, etc.).

Clinician onboarding interface 300 can prompt a clinician to provide personal information (e.g., name, contact information, birthdate, primary address, etc.), one or more locations where the clinician is interested in working (e.g., one or more cities, metropolitan areas, states, etc.), one or more professions, background check information and authorization, and a payment solution by which the clinician can be paid. Onboarding subsystem 110 can create a clinician profile in storage 140 using the information input to clinician onboarding interface 300.

For each profession that a clinician desires to add, clinician onboarding interface 300 can request input/selection of a role (e.g., registered nurse, certified nursing assistant, dental assistant, physical therapist, etc.), any specialties within the role (e.g., emergency department, home care, intensive care unit, etc.), and the number of years of experience in the role and in each identified specialty, among possibly other information. Clinician onboarding interface 300 can also request input and/or uploading of any applicable license and certifications. For example, if the registered nurse role is selected, the clinician may be prompted to identify the RN license number, state, and expiration date and/or to upload a copy of the license. The clinician can be prompted to input and/or upload similar information for each identified specialty (e.g., an issuer, certification number, and expiration date for the ACLS, BLS, CPR, or PALS certification). Clinician onboarding interface 300 can also request input and/or uploading of any malpractice insurance the clinician may have. As clinician provides input to clinician onboarding interface 300, onboarding subsystem 110 can create/update a clinician profile accordingly.

In some embodiments, onboarding subsystem 110 may be configured to use artificial intelligence to assist clinicians with the onboarding process. For example, onboarding subsystem 110 may be configured to prompt the clinician to upload a resume and may use AI module 150 to automatically identify the clinician's profession(s) and to identify where additional information may be needed (e.g., to make the clinician a more attractive candidate). In some embodiments, a machine learning model of AI module 150 may be trained/refined using data obtained via clinician onboarding interface 300 and/or results from scheduling system 100. For example, onboarding subsystem 110 may use a machine learning model to identify which roles, certifications, experience levels, etc. are most likely to cause a clinician to be selected for a shift and/or to be paid more for the shift and can assist clinicians in identifying such characteristics in their profiles. In some embodiments, onboarding subsystem 110 may leverage AI module 150 to automatically verify any license, certification, or other document the clinician may have uploaded (e.g., by using a machine learning model trained using licenses, certifications, etc. to automatically identify and categorize the content of an uploaded document). In some embodiments, onboarding subsystem 110 may additionally or alternatively present such documents for manual review and verification.

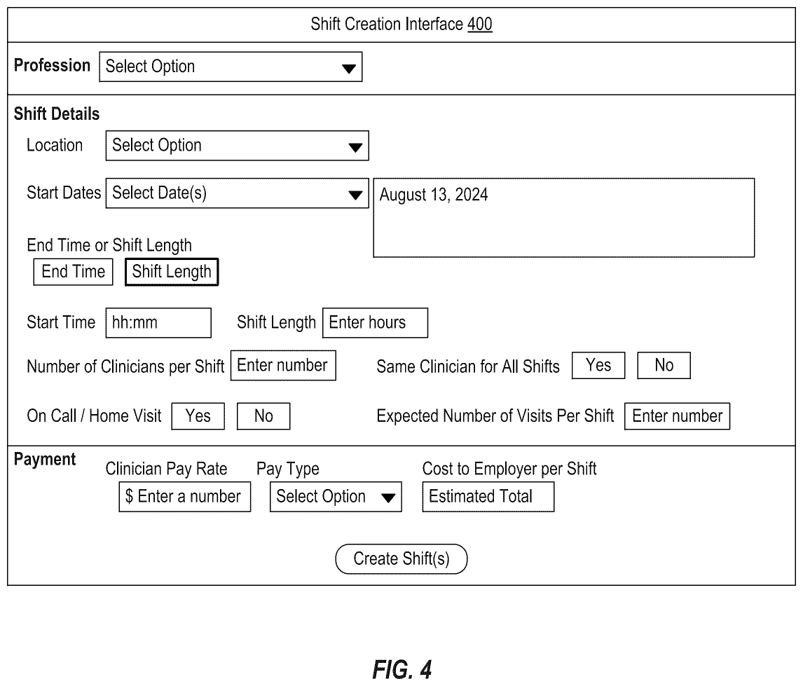

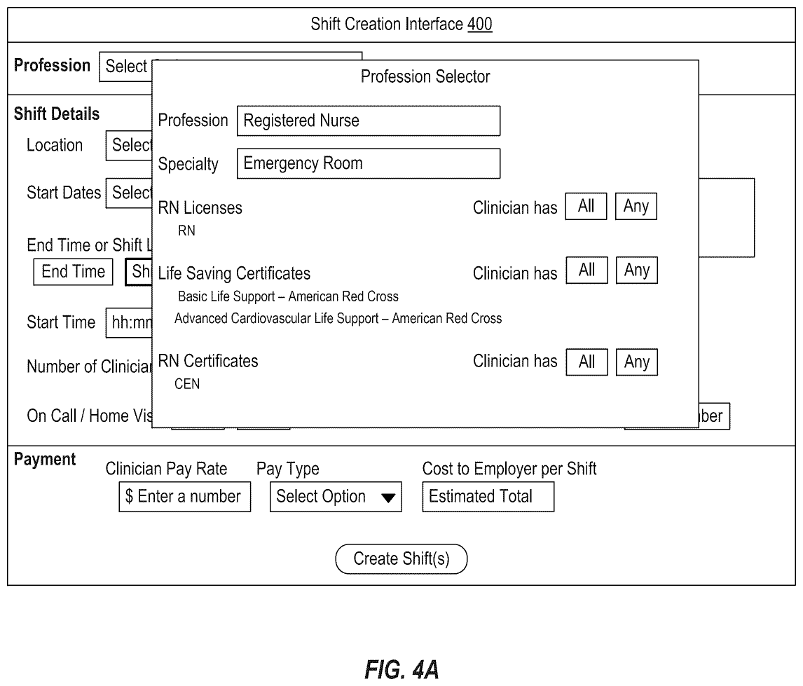

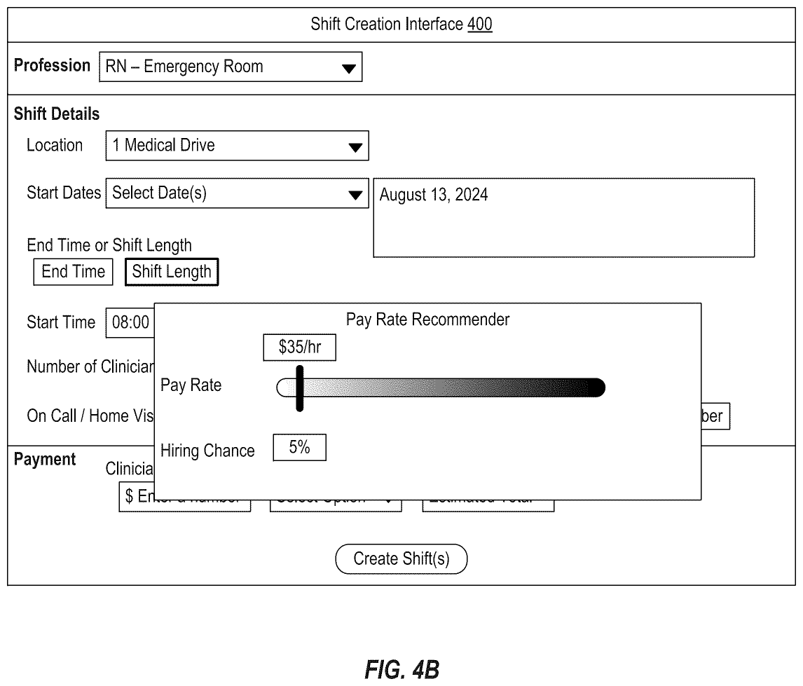

FIGS. 4, 4A, and 4B provide an example of a shift creation interface 400 that shift creation subsystem 120 can present to an employer to enable the employer to create one or more shifts. It is assumed that an employer has been onboarded prior to being able to access shift creation interface 400 such that information about the employer is already stored in an employer profile.

Shift creation interface 400 provides an option for selecting a profession for the shift(s). These professions could include all professions from which clinicians may select or may be limited based on the employer's profile. As represented in FIG. 4A, in some embodiments, shift creation interface 400 may provide a profession selector in which the employer can select a profession as well as any specialties, licenses, and/or certificates a candidate for the shift should have. In some embodiments, profession selector can allow the employer to select whether a clinician must have any or all of a particular type of license or certificate (as opposed to being desired but not required). These selections can subsequently be used by matching subsystem 130 as described below.

Shift creation interface 400 can also provide an option for selecting a start date and an end time or shift length for each of the one or more shifts. In some embodiments, shift creation interface 400 may allow the employer to specify a number of clinicians that are needed for each shift and/or whether the same clinician should fill all shifts (when more than one is created). In some embodiments, such as depending on the employer's profile and/or the selected profession, shift creation interface 400 may provide an option to specify that the one or more shifts are on call or home visit shifts, and in such cases may provide an option to specify an expected number of visits. In some embodiments, shift creation interface 400 may allow the employer to specify whether internal clinicians (e.g., those who are affiliated with the employer) should be preferred over external clinicians. In some embodiments, shift creation interface 400 may provide an option for selecting whether a shift will be automatically filled as opposed to requiring employer review as is described in detail below.

Shift creation interface 400 can also provide an option for selecting a pay rate and pay type (e.g., hourly or total) for the shift. As represented in FIG. 4B, in some embodiments, shift creation interface 400 may provide a pay rate recommender for intelligently recommending a pay rate for the shift(s). For example, shift creation subsystem 120 could leverage AI module 150 to predict a likelihood of a qualified clinician selecting the shift(s) based on the specified paid rate (e.g., when AI module 150 maintains a machine learning model that has been trained using data that defines clinicians who saw and then applied or did not apply for previous shifts having similar criteria). In FIG. 4B, the specified rate is $35/hour, and shift creation subsystem 120 has predicted a 5% chance of the shift being filled. In some embodiments, shift creation subsystem 120 can base such predictions on the results of filling prior similar shifts including on criteria such as the profession, any required specialties, any required licenses and/or certificates, the proximity of the shift, the date (e.g., a holiday), start time, end time, duration, and/or location of the shift, etc.

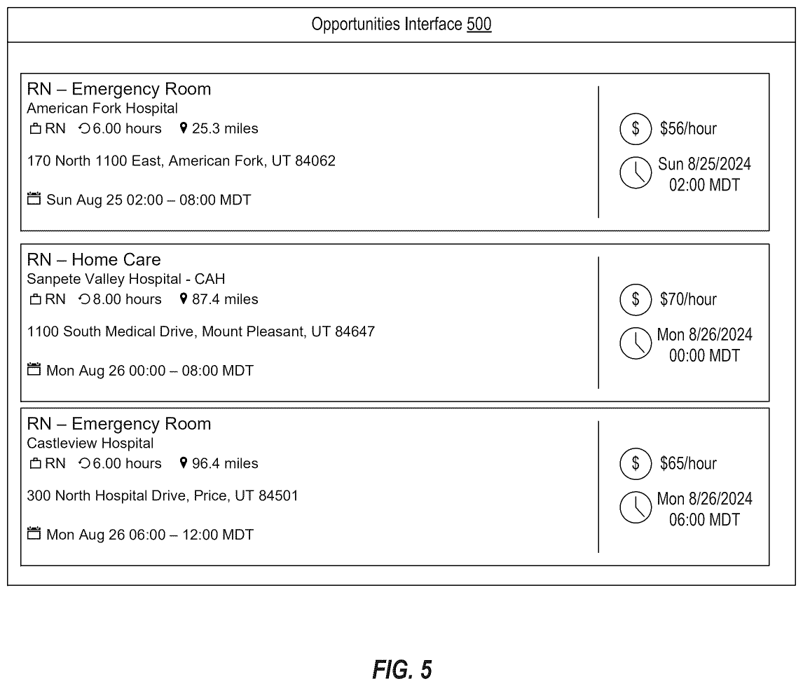

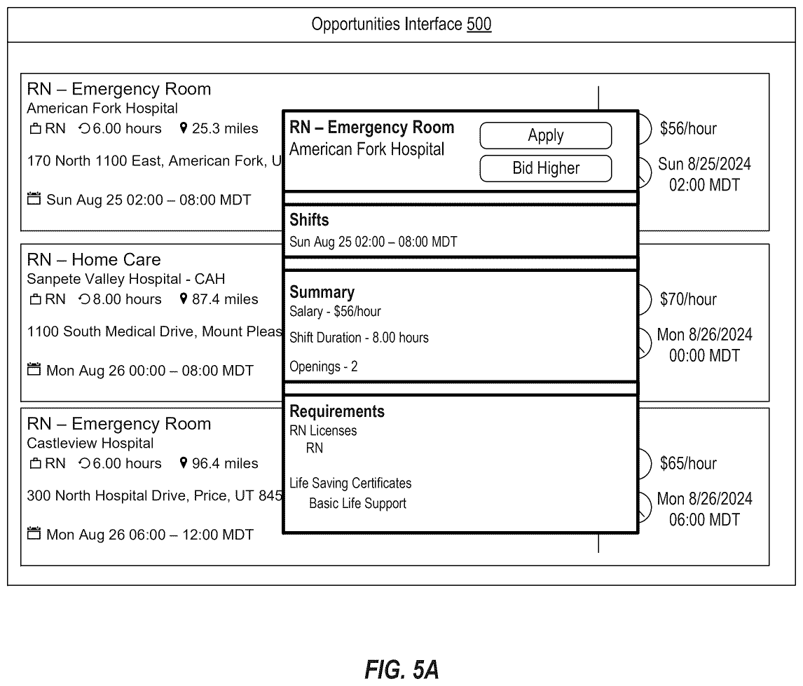

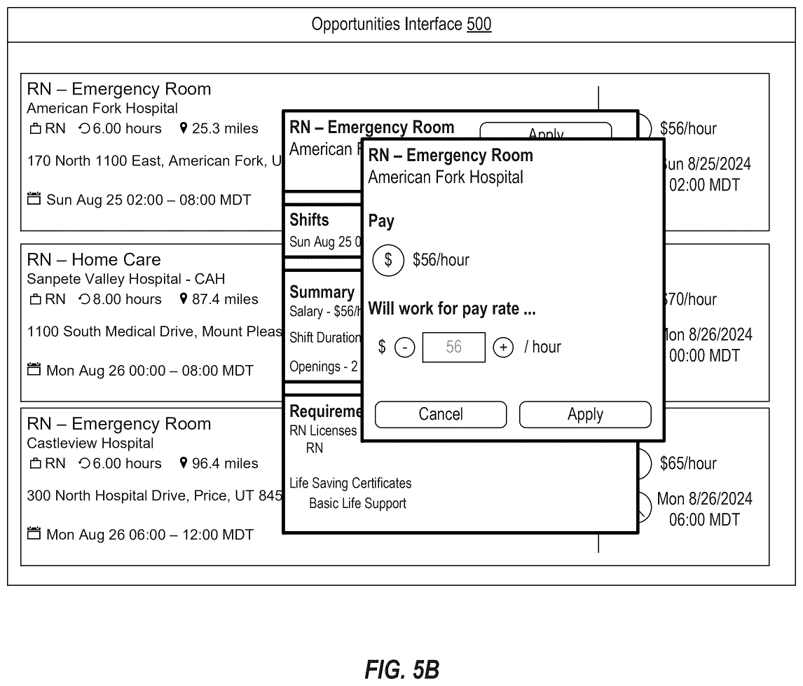

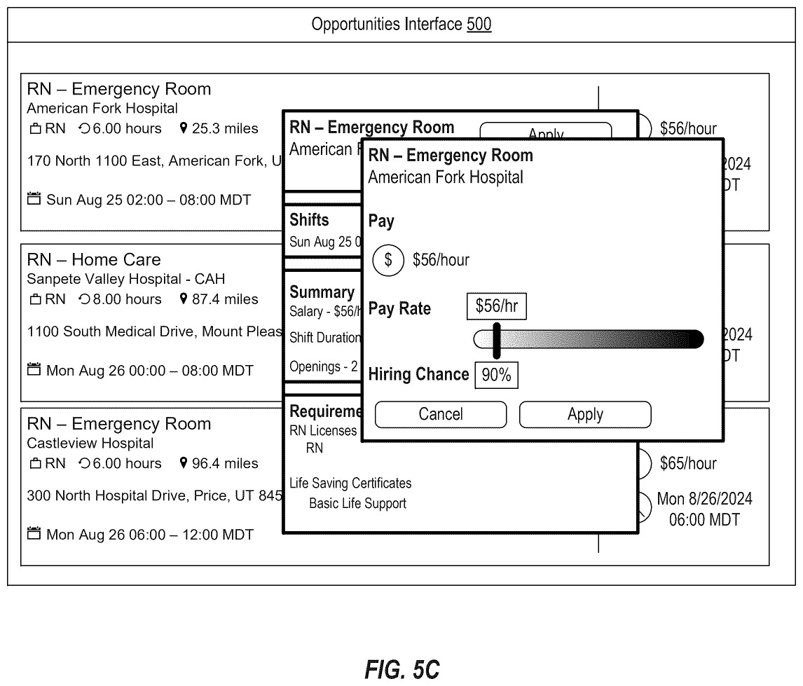

FIGS. 5, 5A, 5B and 5C provide an example of an opportunities interface 500 that matching subsystem 130 can present to a clinician to enable the clinician to apply for one or more shifts that employers have made available in scheduling system 100. When a clinician submits a request to view available shifts, matching subsystem 130 can use any suitable criteria to identify which, if any, of the shifts that have been created within scheduling system 100 should be presented to the clinician. For example, such criteria could include the clinician's qualifications (e.g., the clinician's profession, specialties, licenses, certifications, insurance, etc.), the clinician's location relative to the locations of the shifts (e.g., within a specified distance that the clinician is willing to travel, in a state or states where the clinician is licensed, etc.), any pay thresholds or day/time constraints the clinician may specify, etc.

In some embodiments, matching system 130 may leverage artificial intelligence to predict shifts that are most likely to be interesting to the clinician and/or for which the clinician is most likely to be selected. For example, matching system 130 can be configured to collect and store data defining previously created shifts and the clinicians who were selected to fill the shifts and may use the data to train a machine learning model that matching system 130 uses to predict shifts for a particular clinician and/or for a particular set of criteria in a clinician's request. Such data may be in the form of and/or based on associations between each shift's characteristics and the characteristics of the selected clinician including, for example, the significance of non-required licenses and/or certifications to an employer's decision to select a clinician. In such embodiments, matching system 130 may present such shifts as recommended shifts in addition to presenting other shifts that otherwise match the search criteria.

Regardless of how matching system 130 selects shifts to present to a clinician, matching system 130 can present information about each shift in opportunities interface 500. This information may include the profession and any specialties of a qualified clinician, the location of the shift, a distance of the location from the clinician's specified location, the date, time and duration of the shift, whether there are multiple shifts available under the opportunity (e.g., shifts starting at different times and/or having different durations), and the pay rate for the shift, among possibly other information. In FIG. 5, the available shifts are ordered based on the distance from the clinician, but any suitable ordering could be used.

As represented in FIG. 5A, when the clinician selects one of the available shifts in opportunities interface 500, opportunities interface 500 may be configured to present a sub-interface that provides a summary of and/or additional information about the shift and allows the clinician to apply at the specified pay rate or to submit a higher bid.

As represented in FIG. 5B, when the clinician selects the option to submit a higher bid, opportunities interface 500 may be configured to present a sub-interface which provides an option to input a different pay rate before applying for the shift. In some embodiments, such as is represented in FIG. 5C, the sub-interface may also present a “hiring chance” prediction for the pay rate the clinician inputs. Matching subsystem 130 may be configured to leverage artificial intelligence to predict this hiring chance such as using machine learning as mentioned above.

In the depicted example, matching system 130 has predicted that the clinician has a 90% chance of being selected for the shift if he or she specifies a pay rate of $56/hour, which is the rate the employer specified. Accordingly, this example represents how matching system 130 can consider factors in addition to pay rate to determine the likelihood that a particular clinician will be selected by the employer to fill the shift. For example, using the data from previously filled shifts, matching system 130's machine learning model could learn that the employer has regularly selected other clinicians having similar credentials/experience as this clinician for shifts having similar characteristics/criteria as this shift, and may therefore predict that the clinician is very likely to be selected at the employer's specified pay rate. If the clinician increases the pay rate, matching system 130's machine learning model can again be leveraged to predict the hiring chance at the increased pay rate (e.g., by predicting based on previously filled shifts that the clinician has a 40% hiring chance at a pay rate of $70/hour). By leveraging machine learning techniques or other AI techniques, matching system 130 can predict the hiring chance with high accuracy and can therefore better assist the clinician in obtaining shifts.

In some embodiments, matching system 130 may enable the clinicians to submit bids for different start and/or end times for the shift in a similar manner as they may submit higher pay rates. For example, opportunities interface 500 may provide a slider with handles for the start and end times for the shift. When applying, the clinician may adjust the slider's handles to bid on a different start and end time.

In some embodiments, matching subsystem 130 can be configured to enable a clinician to apply for a shift before completing a clinician profile (i.e., before onboarding) with scheduling system 100. For example, it may take time to review and confirm the clinician's credentials and/or to perform a background check, and such a delay may otherwise prevent a qualified candidate from applying for a shift. This may oftentimes be an issue in scenarios where the clinician has contacted the employer and been instructed to apply for a shift via scheduling system 100. In such cases, matching subsystem 130 can annotate a clinician's application for a shift to indicate that the clinician has not yet been onboarded. The employer may then take this into account when considering which clinicians to schedule for a shift as described below.

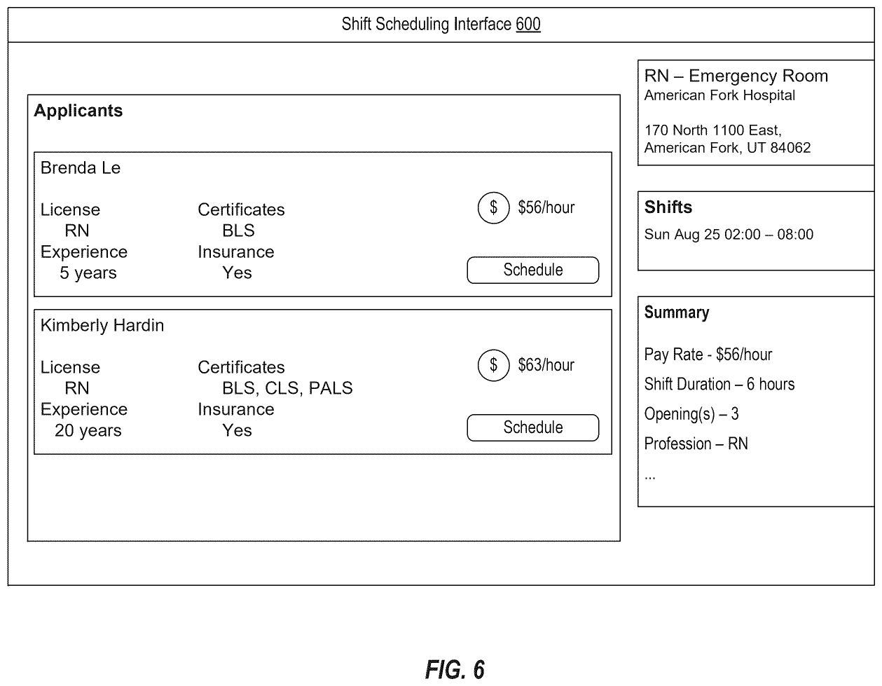

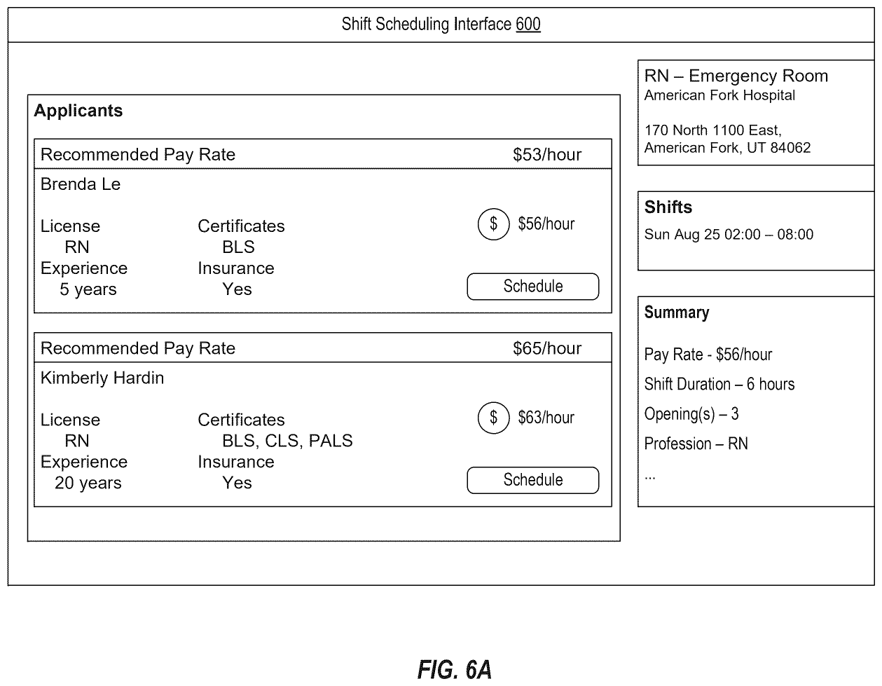

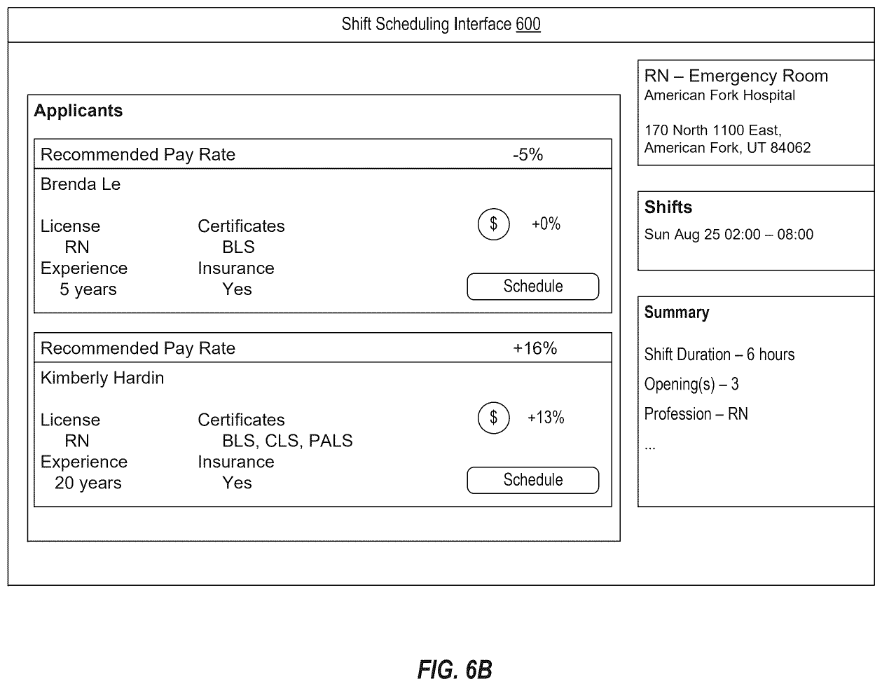

FIGS. 6, 6A and 6B provide an example of a shift scheduling interface 600 that matching subsystem 130 can present to an employer to enable the employer to schedule one or more clinicians who have applied for a shift that the employer has made available in scheduling system 100. In FIG. 6, it is assumed that the employer has selected a particular shift and therefore information about the selected shift is presented at the right side of shift scheduling interface 600. Additionally, shift scheduling interface 600 can provide information about each clinician who has applied. In this example, it is assumed that Brenda Le and Kimberly Hardin have applied for the shift at American Fork Hospital. For each clinician, shift scheduling interface 600 can present the pay rate, start/end times, or any other bid that the clinician specified when applying. For example, it is assumed that Brenda Le applied at the pay rate the employer specified ($56/hour) and that Kimberly Hardin input a bid for $63/hour. To assist the employer in selecting which of the clinicians to schedule for the shift, shift scheduling interface 600 can display each clinician's licenses, certificates, experience, insurance, etc. In this way, the employer can quickly make an informed decision based on the clinicians'qualifications and the pay rates.

In some embodiments, shift scheduling interface 600 can include an indication of whether a clinician is internal or external to the employer such as when the employer has indicated a preference for scheduling internal clinicians. In some embodiments, shift scheduling interface 600 may be configured to redact the name of the clinician to promote hiring based on merit and to prevent profiling. In some embodiments, scheduling system 100 may allow an employer to identify one or more clinicians as favorites, and in such embodiments, shift scheduling interface 600 may be configured to present any favorited clinicians with a higher priority.

In some embodiments, such as is shown in FIG. 6A, shift scheduling interface 600 can include a recommended pay rate for each clinician. For example, matching subsystem 130 could be configured to leverage AI module 150 to obtain a recommended pay rate that is predicted (e.g., using a machine learning model) based on similar shifts and clinicians. More particularly, AI module 150 could implement a machine learning model that is trained using data defining historical shifts, the clinicians who were scheduled for such shifts, and the pay rates the clinicians received.

In some embodiments, it may be desirable to hide the pay rate for a shift and/or that a clinician has requested (e.g., if an employer uses support staff for scheduling as opposed to administrative staff). In such cases, shift scheduling interface 600 may present the clinicians' pay rates as a percentage of the pay rate the employer specified such as is shown in FIG. 6B. By representing the clinicians'pay rates as percentages, including possibly the recommended pay rates, the scheduler can still make an informed decision without needing to know how much the clinician will be paid.

As suggested above, in some embodiments, scheduling system 100 may allow the employer to select to have a shift be automatically scheduled. For example, shift creation interface 400 could provide an option to select an automatic scheduling option. In some embodiments, shift creation interface 400 could allow the employer to specify a different set of criteria/qualifications that a clinician must meet to be eligible to be automatically scheduled. In other embodiments, any clinician that is eligible to apply may also be eligible to be automatically scheduled.

In embodiments where a shift is configured for automatic scheduling, an employer may not need to access shift scheduling interface 600 to schedule a clinician for a shift. Instead, matching subsystem 130 may be configured to automatically schedule a clinician once the clinician has applied as long as any required criteria/qualifications are met. In some embodiments, such criteria could include the clinician's pay rate and could be defined as a maximum pay rate. In some embodiments, the employer could rely on AI module 150 for this automatic scheduling functionality. For example, the employer could authorize automatic scheduling for any clinician whose pay rate is no greater than the recommended pay rate that AI module 150 predicts for that clinician.

In embodiments where an employer selects a clinician who has not yet been onboarded, matching subsystem 130 can be configured to tentatively schedule the clinician while the onboarding process is completed. If onboarding fails, matching subsystem 130 can notify the employer. Otherwise, matching subsystem 130 can proceed directly with scheduling the clinician once onboarding is completed without further involving the employer.

In some embodiments, scheduling system 100 may employ a status system to further assist employers and/or clinicians with scheduling. For example, when a clinician has completed a shift for which he or she was scheduled within scheduling system 100, scheduling system 100 may be configured to prompt the employer to review the clinician. This review could consider any suitable factor such as, for example, whether the clinician arrived on time, worked throughout the shift, had good bedside manner, was quick thinking, had good mobility, worked well with others, etc. In some embodiments, the clinician could be prompted to provide a similar review of the employer (e.g., to confirm whether the shift matched what the employer specified, to rate the facility, etc.). When a clinician or employer receives a review, scheduling system 100 can adjust the clinician's or employer's status accordingly. By using statuses in this manner, scheduling system 100 can assist employers in identifying clinicians who are reliable and will do the job well, and can assist clinicians in identifying employers that are desirable to work for. In some embodiments, scheduling system 100 can be configured to automatically adjust a clinician's or employer's status when a cancellation occurs. For example, in some embodiments, if a clinician or employer cancels a shift within a threshold amount of time before the shift's start time, the respective status can be reduced to reflect the lack of reliability. In some embodiments, the magnitude of the reduction can be based on how close to the start time the cancellation occurred (e.g., a greater penalty for cancelling at the last second as opposed to a day in advance). In some embodiments, a status system may use numerical scores as opposed to levels/categories.

In some embodiments, matching subsystem 130 may consider a clinician's status as part of the automatic scheduling process. For example, an employer may specify the minimum status level a clinician must have to be eligible for automatic scheduling or a default status level could be used.

In summary, a scheduling system configured in accordance with embodiments of the present disclosure can facilitate the process of scheduling shifts. By leveraging artificial intelligence, both employers and clinicians can make more informed decisions while streamlining the scheduling process.

Embodiments of the present disclosure may comprise or utilize special purpose or general-purpose computers including computer hardware, such as, for example, one or more processors and system memory. Embodiments within the scope of the present disclosure also include physical and other computer-readable media for carrying or storing computer-executable instructions and/or data structures. Such computer-readable media can be any available media that can be accessed by a general purpose or special purpose computer system.

Computer-readable media are categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves. Because computer storage media and transmission media are disjoint categories, computer storage media does not include signals or carrier waves.

Computer-executable instructions comprise, for example, instructions and data which, when executed by a processor, cause a general-purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, smart watches, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present disclosure can be hosted in a cloud environment.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method, implemented by a scheduling system, for scheduling a shift, the method comprising:
receiving, from a first clinician, a request to view shifts, the request specifying criteria;
presenting, to the first clinician, one or more shifts that match the criteria of the request including a first shift offered by a first employer, the first shift including a first pay rate that the first employer is offering to pay for the first shift;
receiving, from the first clinician, input selecting the first shift for which the first clinician desires to apply, the input including a second pay rate different from the first pay rate that the first clinician would like to be paid for the first shift; and
presenting, to the first employer, one or more clinicians, including the first clinician, who have applied for the first shift, wherein the first clinician is presented with the second pay rate rather than the first pay rate.

2. The method of claim 1, further comprising:
predicting, using artificial intelligence, a recommended pay rate for the first clinician;
wherein the first clinician is presented with the recommended pay rate for the clinician and the second pay rate.

3. The method of claim 2, wherein the recommended pay rate for the first clinician is predicted based on characteristics of other clinicians and characteristics of other shifts.

4. The method of claim 2, wherein the first shift is presented to the first clinician with the recommended pay rate for the first clinician.

5. The method of claim 4, wherein the second pay rate is the recommended pay rate for the first clinician.

6. The method of claim 1, wherein the second pay rate is presented as a percentage above or below the first pay rate.

7. The method of claim 1, further comprising:
receiving, from the first employer, input that defines the first shift, the input specifying the first pay rate.

8. The method of claim 7, further comprising:
presenting, to the first employer, the first pay rate as a recommended pay rate for the shift.

9. The method of claim 8, wherein the recommended pay rate for the shift is predicted using artificial intelligence based on previous shifts that have been scheduled via the scheduling system.

10. The method of claim 1, wherein the criteria includes at least one of:
one or more medical professions;
one or more medical specialties;
one or more medical licenses; or
one or more medical certificates.

11. The method of claim 1, wherein the first clinician is presented to the first employer with an indication that the first clinician has not been onboarded to the scheduling system.

12. The method of claim 1, further comprising:
receiving, from a second clinician, a request to apply for the first shift; and
automatically scheduling the second clinician for the first shift.

13. The method of claim 12, further comprising:
determining that the second clinician's request to apply for the first shift matches criteria for automatic scheduling;
wherein the second clinician is automatically scheduled for the first shift in response to the determination.

14. The method of claim 13, wherein determining that the second clinician's request to apply for the first shift matches criteria for automatic scheduling comprises determining that one or more of a pay rate specified by the second clinician, a status level of the second clinician, or qualifications of the second clinician matches the criteria for automatic scheduling.

15. A method, implemented by a scheduling system, for scheduling a shift, the method comprising:
receiving, from a first employer, input that defines a first shift;
based on the input that defines the first shift, predicting, using artificial intelligence, a recommended pay rate for the first shift; and
presenting, to the first employer, a plurality of clinicians who have applied for the first shift, each of the clinicians being presented with a clinician pay rate, wherein the clinician pay rate for at least one of the clinicians is different from the recommended pay rate.

16. The method of claim 15, wherein the clinician pay rate for a first clinician of the plurality of clinicians was selected by the first clinician when applying for the first shift.

17. The method of claim 16, further comprising:
wherein the clinician pay rate for the first clinician is predicted using artificial intelligence based on characteristics of other clinicians and characteristics of other shifts.

18. A method, implemented by a scheduling system, for scheduling a shift, the method comprising:
receiving, from a first employer, input defining a first shift including a medical profession for the first shift, a duration of the first shift, and a first pay rate for the first shift;
presenting, to a first clinician, a plurality of shifts including the first shift;
receiving, from the first clinician, a request to apply for the first shift, the request specifying a second pay rate;
presenting, to the first employer, a plurality of clinicians including the first clinician who have applied for the first shift, wherein the first clinician is presented with the second pay rate;
receiving, from the first employer, input that selects the first clinician to schedule for the first shift; and
scheduling the first clinician for the first shift.

19. The method of claim 18, further comprising:
in conjunction with receiving the first pay rate for the first shift from the first employer, presenting, to the first employer, a hiring chance prediction based on the first pay rate.

20. The method of claim 18, further comprising:
in conjunction with receiving the second pay rate from the first clinician, presenting, to the first clinician, a hiring chance prediction based on the second pay rate.
